(19) United States
(12) Patent Application Publication
(10) Pub. No.: US 2023/0408080 A1
(43) Pub. Date: Dec. 21, 2023

(54) LUMINAIRE WITH INTEGRATED RF COMMUNICATION

(71) Applicant: SIGNIFY HOLDING B.V., EINDHOVEN (NL)

(72) Inventors: Ronald Johannes GELTEN, GELDROP (NL); Khalid Kamran AZIZ, AMSTERDAM (NL)

(21) Appl. No.: 18/035,740

(22) PCT Filed: Nov. 4, 2021
(86) PCT No.: PCT/EP2021/080682

§ 371 Date: May 6, 2023

(30) Foreign Application Priority Data
Nov. 6, 2020 (EP) 20206244.4
Sep. 16, 2021 (EP) 21197064.5

(51) Int. Cl. F21V 33/00; F21V 29/70; H01Q 1/22

(52) U.S. Cl. CPC F21V 33/00; F21V 29/70; H01Q 1/22; H04W 88/08

(57) ABSTRACT

Disclosed is a luminaire comprising a lighting unit, and a wireless RF communication device, wherein at least a part of the lighting unit and at least a part of the wireless RF communication device are in thermal contact with a same heat sink component. Examples of wireless communication devices include wireless mmWave backhaul devices for 5G communication.

### FIELD OF THE INVENTION

The invention relates to luminaires, especially but not limited to outdoor luminaires, with integrated RF communication capabilities.

### BACKGROUND OF THE INVENTION

Along with the development of the mobile telecommunication technologies, the user data consumption has grown rapidly in the last decade. Thus, a higher download and upload speed and a greater bandwidth are needed to meet the user requirements. Wireless connectivity standards and specifications that accommodate these growing needs are driven by standardization bodies such as 3GPP and IEEE. Among the general audience the 3GPP telecommunication standards of 2G, 3G, 4G and 5G are most commonly known. An important aspect of the 5G standard is that higher radio frequencies are used. While the 4G-LTE frequencies range from 700 MHz-2.7 GHz, 5G frequencies are provided in two sets: wherein the first set ranges from 450 MHz to 6 GHz and the second set ranges from 24.25 GHz to 52.6 GHz. Generally speaking, the band of radio frequencies in the electromagnetic spectrum from 30 to 300 GHz is called Extremely high frequency (EHF). Since the radio waves in this EHF band have wavelengths in the order of millimeters, EHF band is also called millimeter band and a radio wave in this band is called a millimeter wave, or mmWave.

A typical mmWave communication device comprises a baseband section for providing different functions, such as a power supply function, an interfacing function, a data storage function and a data processing function, and one or more radio frequency (RF) sections each comprising a transmitter and/or a receiver. The transmitter and/or receiver needs to connect to an antenna for transmitting and/or receiving a radio wave. Typically, for frequencies above 6 GHz, physical separation between the radio frequency sections and the antenna should be minimized due to excessive signal losses in the cables otherwise.

The baseband section and the radio frequency section(s) can be arranged as a single module or as different modules. In order to secure a reliable operation of the mmWave communication device, these sections need to be mechanically secured, e.g., by brackets, against vibrations and impact.

A typical mmWave communication device also comprises cooling sections, e.g., a heat sink for transferring dissipated heat of the device to a cooling medium (typically air), an internal heat spreader and/or a thermal pad for transferring heat from an internal heat source (e.g., a processor) to the heat sink. The heat sink is normally made of metal, such as aluminum or copper, and is provided with a large surface area, e.g., by means of fins, in contact with the cooling medium.

Since the typical mmWave communication device is designed for outdoor environment, it needs to resist moisture, water, dust, etc., by weatherproofing methods, e.g., by providing a waterproofing encapsulation housing, by providing sealings for cable feedthroughs and connectors, and/or by providing separated compartments for different sections.

All the above considerations tend to increase size and weight of the mmWave communication devices.

Further, the range for travel distances through air of radio signals decreases with increased frequencies and thus, a larger number of mmWave communication devices (e.g., base stations) are needed for the deployment of the higher frequency radio communication for covering an area, comparing to the deployment of lower frequency radio communications.

Moreover, the ability of radio signals to penetrate solid objects (such as cars, human bodies, trees, and walls) decreases with increased frequencies. For mmWave, communications between two end points normally require a clear line of sight (LOS) without obstruction in between. In other words, the mmWave communication base station must be able to “see” the user equipment (e.g., a smartphone) it is communicating with to enable the mmWave communication. Thus, the mmWave communication device must be installed in a location which is not only close enough to the users but also without any obstructions in between. This is challenging in urban environments and the consequence is that radio equipment has to be hosted (installed) in proximity to where people and traffic reside.

Thus, it would be desirable to provide an improved solution for mmWave communication.

The outdoor lighting grid (e.g. street lighting) offers a near-ideal grid to deploy wireless communication infrastructure (WiFi, telecommunications 4G/5G, E-band and V-band backhaul) because it offers proximity (to people, traffic), scale (ubiquitous presence), granularity (distance between poles matches typical requirements of RF network design) and elevation (height to mount equipment for signal coverage). One key challenge to get acceptance from cities (permits) and the public is to provide aesthetic solutions and minimized form factors. There is a strong wish to hide technology in unseen places.

It is helpful to note that the generation, the consumption and the transportation of digital data in outdoor areas (public spaces as well as industrial areas, campuses, enterprises and the like) can be roughly divided in three virtual “hierarchical layers” or “groups”. Although there is some similarity with layers of network communication in the OSI model, they are not one-to-one related. There are many ways to define such layers or groups, and below description is just an example:

(1) Access Layer or Application Layer.
This includes, utilizes or is enabled by various equipment (“end points”) that generate data (such as cameras and sensors), consume data (such as digital displays) or connect to devices that generate and/or consume data (such as Wi-Fi equipment an/or telecommunications equipment connecting to mobile phones, sensors or other devices). Equipment may consist of a combination of these, e.g. a sensor or camera with embedded telecommunications device. The density of equipment in this layer can be very high, which is why the 5G telecommunications standard will support up to one million devices per square kilometer.

(2) A Fiber Optics Layer.
A network of fiber optic cables is used to provide a data connection from the end points to the internet, to control rooms (e.g. for closed-circuit TV cameras, CCTV), telecommunications core networks etc.

(3) A Wireless Transport Layer.
Increasingly, a wireless data transport layer is “inserted” in between layer 1 (the access layer or application layer) and layer 2 (the fiber optics layer). There are several reasons for this, the main reason being that implementing fiber optics connections to end devices is costly, time consuming and disruptive for the city (because the cables are usually laid underground). The wireless transport layer wirelessly transports data from one or multiple end devices to an optical fiber location (fiber point-of-presence, or POP). For end devices that generate limited amounts of data (e.g. up to several kilobits per day), a low-bandwidth transport layer is sufficient. There are many narrowband protocols and devices available for this. For end devices that generate high amounts of data (e.g. up to multiple megabits per second) there are limited options available. Telecommunications equipment that is typically applied in layer 1 is sometimes used for this purpose. There are various other devices that can communicate wirelessly with high data rates, either based on radio-frequency (RF) technology or optical (light) technology. Data transport in this layer is often referred to as back haul, mid haul or front haul.

The present disclosure aims at wireless communication devices using a radio frequency (RF) spectrum for abovementioned layer 3 applications. It may also apply to communication devices operating in abovementioned layer 1.

Known RF communication devices use heat sinking, convection or conduction integrated in the building blocks of the devices (i.e. the baseband unit, the radio, the antenna or combinations thereof), resulting in increased size and weight of such RF communication devices. The baseband unit and the radio may be integrated in one module. When attached to light poles of the street lighting grid, this leads to technical problems related to strength of the light poles as well as acceptance by cities and citizens for aesthetic reasons. Strength of the light poles are affected by the additional weight, wind load on RF communication devices and holes drilled in the columns to feed through wires for electricity and data connections.

### SUMMARY OF THE INVENTION

It is an object of the invention to provide a solution addressing at least some of problems mentioned above.

The inventors have recognized that by splitting the RF communication device into functional components/building blocks/units, and re-configuring the layout of these units, they could optimize the use of the luminaire for heat sinking not only the heat generated by the lighting components in the luminaire but also for heat sinking heat generated by the RF communication components. Heat sinking, in the context of this present disclosure, includes two main aspects: (i) spreading heat that is generated by equipment through a conductive material and (ii) subsequently transferring this heat to an outside environment, which is typically ambient air.

Furthermore, by incorporating RF communication components inside the luminaire as much as possible, an increase of the Effective Projected Area (EPA), which is a coefficient used by the lighting industry to determine how much force a luminaire will apply to the mounting brackets or pole at a given wind velocity, can be minimized. In other words: forces resulting from wind load are minimized, thus minimizing the risk of overloading/overstressing the mechanical structure of the light pole. By utilizing the metal structure of the luminaire as the heat sink for lighting components and RF communication components, the weight increase can be minimized, thus minimizing the risk of overloading/overstressing the mechanical structure of the light pole. Furthermore, the mechanical housing of the luminaire typically also provides protection of lighting components against external influences such as weather, dust and insects. By integration of the RF communication equipment inside the luminaire, the luminaire housing provides protection for RF communication equipment as well.

The combination of the above technical measures also leads to minimization of equipment size, which has a direct effect on aesthetic appearance. Furthermore, reduced size of the RF communication equipment facilitates further integration options in the mechanical structure of pole, pole attachments such as arms and brackets, as well as in luminaires.

Examples of RF communication devices include any device that creates bidirectional wireless communication between the fiber point of presence (POP) and one or more “end devices”, whereby these end devices are electronic units that consume or produce data themselves (e.g. sensors, cameras, digital displays), and/or provide data connections to third party devices, often via paid subscriptions (e.g. WiFi access points, telecommunication radios). The RF communication devices themselves act as (OSI layer 2) switches and/or (OSI layer 3) routers. In essence, they only transport data from one end of the network (the access layer or end devices) to the other end of the network (the fiber layer or POP) and vice versa. The RF devices themselves do not essentially add or reduce network traffic, other than some additional overhead to ensure security and packet routing. This added overhead is only used within the RF communication network, and not used or seen by the end devices nor by the fiber POP. In order to provide sufficient bandwidth, the RF devices typically operate at frequencies above 6 GHz, preferably about 30 GHz, and preferably in the 60 GHz band (57-71 GHz). Such RF devices are typically capable of communication speeds in the range of gigabits per second (Gbps) and may be used specifically, but not exclusively for data backhaul, midhaul and fronthaul. These terms are used to indicate different types of data connections in the telecommunications industry. Generally speaking, backhaul is a connection to the internet or telecommunications core network; fronthaul is a data connection between a controller or central unit or baseband unit and a (remote) radio unit; midhaul is typically a data connection between two controllers or central units or distributed units. In some cases, backhaul is also used to describe a connection between non-telecommunications devices (e.g. WiFi access points, cameras) and the fiber POP.

The invention is defined by the appended claims and includes a luminaire comprising a lighting unit and a wireless RF communication device according to independent claim 1 and use of such a luminaire in network applications according to independent claim 11 to 14. Preferred embodiments are claimed in the dependent claims.

### BRIEF DESCRIPTION OF THE DRAWINGS

Examples will now be described, by way of example only, with reference to the accompanying drawings, in which:

FIG. 1 shows prior art examples of wireless backhaul equipment co-located with lighting infrastructure.

FIG. 2A shows an existing outdoor luminaire with FIG. 2B being conceptually the same luminaire with a typical off the shelf wireless backhaul RF communication device mounted on top;

FIG. 3A to 3E show examples of optimized designs of a luminaire with wireless backhaul RF communication functionality;

FIGS. 4A and 4B show another existing outdoor luminaire with FIG. 4C being a perspective internal view of that luminaire with optimized design for wireless backhaul RF communication functionality integration.

FIG. 5A to 5D show examples of heat sinking luminaire housing part(s) and connections between at least a part of an integrated wireless RF communication device with the heat sinking housing part(s).

FIG. 6A to 6C show further examples of heat sinking luminaire housing part(s) and connections between at least a part of an integrated wireless RF communication device with the heat sinking housing part(s).

### DETAILED DESCRIPTION OF THE EMBODIMENTS

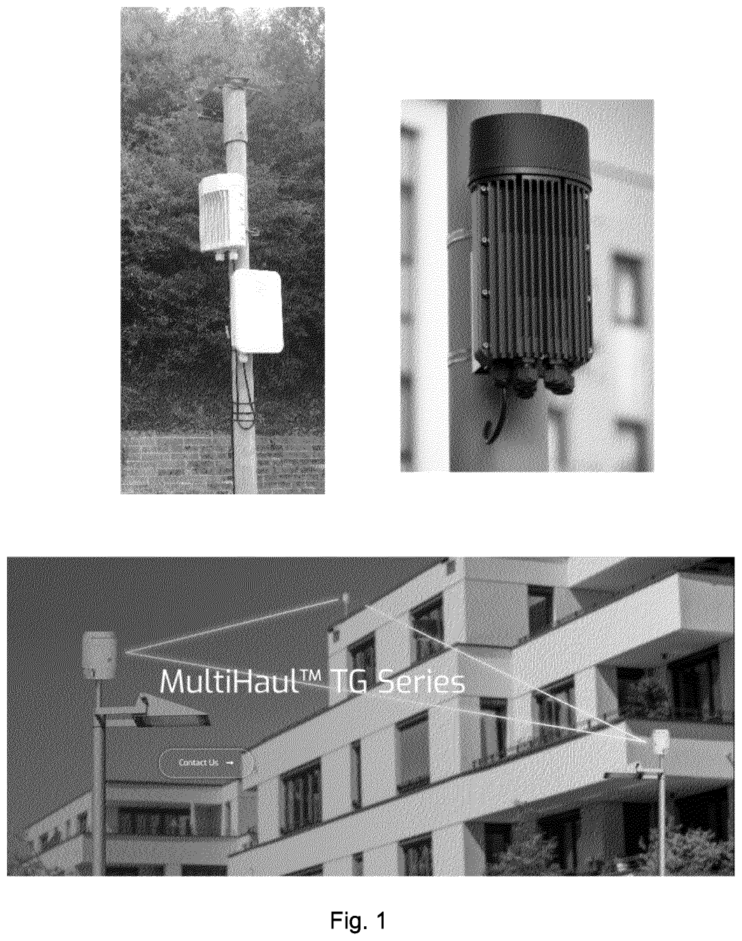

As an example of concept that uses wireless backhaul equipment mapped onto the lighting grid or co-located with the lighting infrastructure, reference is made to the Terragraph initiative by Facebook (https://terragraph.com/). Two examples of Terragraph compliant wireless backhaul products are the Siklu N366 product (https://www.siklu.com/product/multihaul-series-tg/) and Cabmium cnWave product (Cambium Networks|60 GHz cnWave V5000). There are other vendors with equipment that is relevant for layer 3 applications (see background of the invention), such as CCS (https://www.ccsl.com/), Vubiq Networks (https://www.vubignetworks.com/), Movandi (https://movandi.com/products/), Pivotal Commware (https://pivotalcommware.com/). FIG. 1 shows prior art examples illustrating the size of these products compared to a typical street lighting luminaire or street pole. As can be seen from these prior art examples, these RF products are applied as highly visible pole attachments. The size and location of the equipment creates objections around aesthetics and can create complications with line-of-sight, i.e. the ability of the equipment to create connections without obstructions from objects such as city furniture, buildings or trees. The weight, in combination with drilling of holes in the columns for electrical cables and/or data cables, may create unacceptable degradation of structural integrity of the column.

The term “luminaire” are used herein refers to an implementation or arrangement of one or more lighting units in a particular form factor, assembly, or package, wherein the luminaire's primary function is to provide illumination to its environment. Outdoor luminaires are luminaires adapted to be used in outdoor environments and adapted to provide, as their primary function, illumination to the outdoor environment. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources a, alone or in combination with other non LED-based light sources.

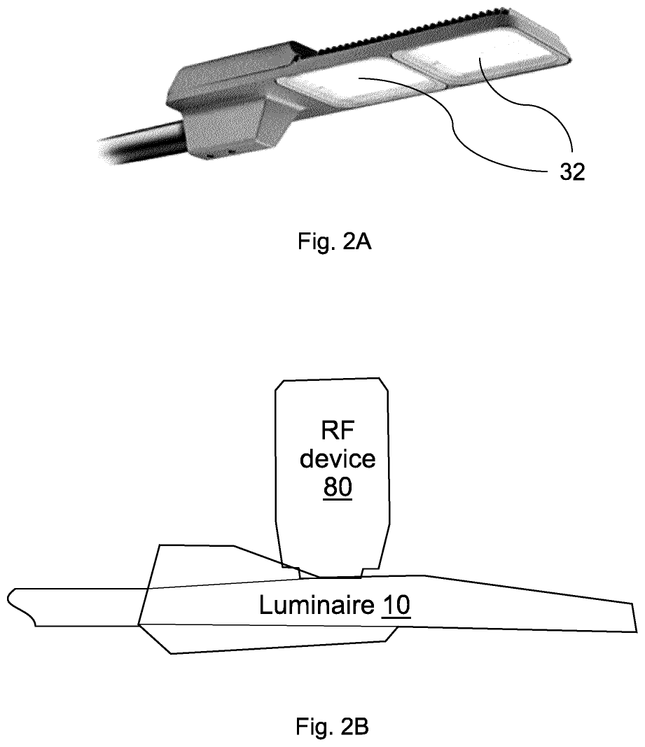

FIG. 2A shows a picture of an existing outdoor luminaire without wireless RF communication device mounted onto it. The luminaire comprises a lighting unit comprises light sources 32, for example an LED arrangement mounted on a PCB. In FIG. 2B, a general outling of an existing outdoor luminaire 10, similar to the one shown in FIG. 2A, with a RF communication device 80, such as a typical mmWave (60 GHz) RF communication device, mounted on top is shown. As can be seen, the addition of wireless backhaul equipment onto such luminaire will change dramatically the EPA of the luminaire or the aesthetic appearance.

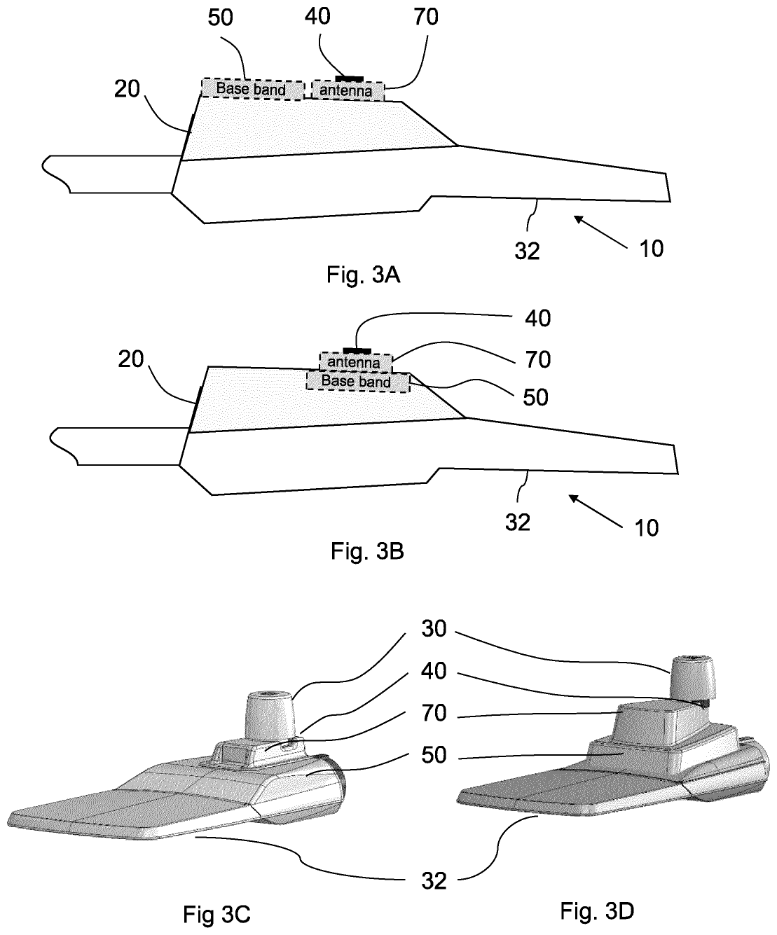

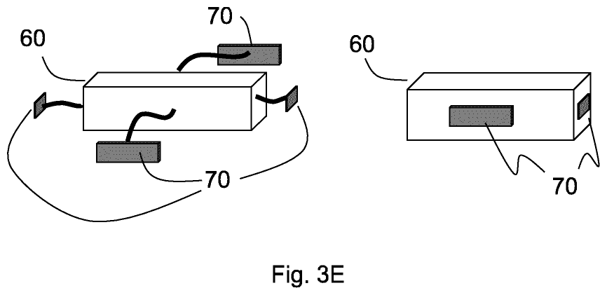

By separating the functional component or building blocks of these wireless backhaul devices into different functional units and optimizing the design of the cover/housing of the luminaire to include some or all of the functional units of the wireless backhaul device, the size and Effective Projected Area EPA can be optimized, costs can be reduces and aesthetics improved. FIG. 3 shows several examples based on the conceptual luminaire design of FIG. 2A. The metal housing 20 of luminaire 10, or part of the housing, acts as heat sink. Because the metal material is not transparent for antenna signals, the antenna 70 (potentially combined with radio 60 as illustrated in FIG. 3E) and potentially a GPS unit 40 need to be arranged outside the luminaire 10, e.g., on the top-side of the luminaire 10. The baseband unit BBU 50 (and possibly the radio 60) can sit inside or outside the luminaire 10. Preferred location is inside, because the BBU can be attached to mains power (depending on the product) and so that the metal housing can provide shielding against electromagnetic interference (EMI), therewith providing or improving electromagnetic compatibility (EMC). The luminaire 10 provides heat sinking and reliable power for all its components, including surge protection against voltage peaks from lightning strikes or other events. The above considerations, or similar, apply for other RF devices, including small telecommunications units. FIGS. 3A and 3B illustrate possible locations of functional units of the RF equipment in or on the luminaire, i.e., inside the luminaire housing 20 or outside the luminaire housing 20. FIGS. 3C and 3D illustrate possible resulting embodiments. These embodiments also include a lighting control unit 30, which has the function of controlling the light (e.g., on/off/dim) without interfering with the operation of the RF communication equipment. The luminaires in FIGS. 3A and 2B can also have such a lighting control unit. As can be seen, the impact on EPA of the luminaire is much smaller than in FIG. 2B. FIG. 3E schematically depicts two alternative configurations of a radio 60 with, in the depicted case, 4 associated antennas 70. On the left hand side of the figure, the antennas 70 are functionally connected to but separate from the radio 60, which allows the radio 60 to be integrated with the baseband unit 50 in the inside of the luminaire 10, i.e., within the metal housing 20 of the luminaire 10. On the right hand side of the figure, the antennas 70 are integrated with the radio 60 in a single block or module, in which case the radio+antenna module is preferably located outside the metal housing 20 the luminaire 10.

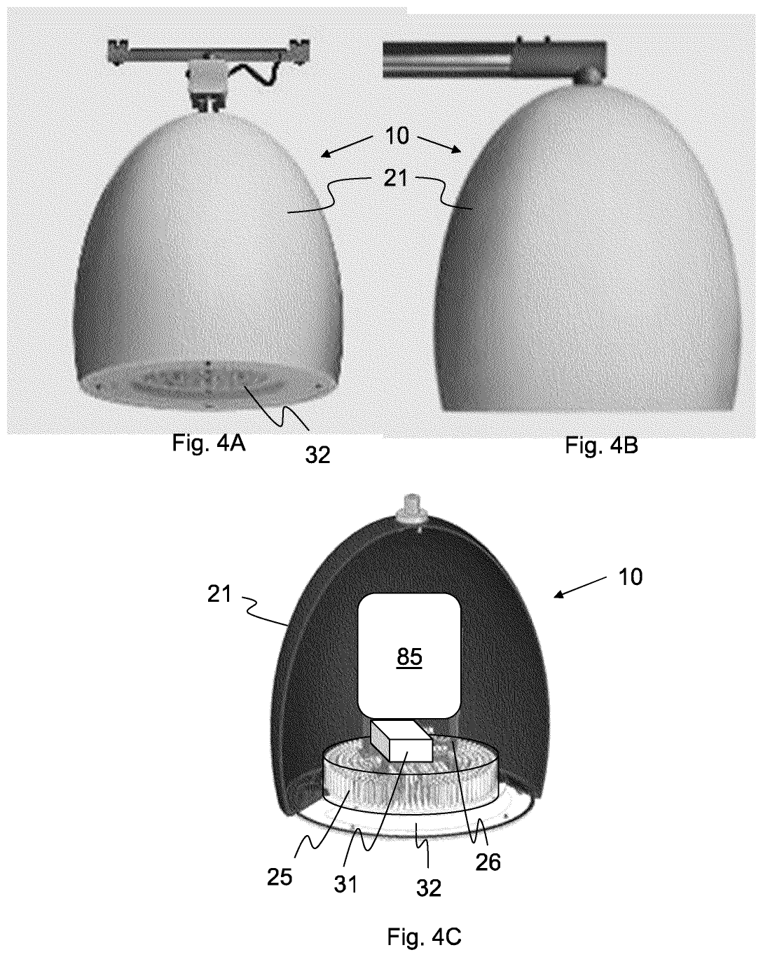

A second example embodiment is shown in FIGS. 4A, 4B and 4C. Here, the plastic (polycarbonate, PMMA or other material) housing 21 of the luminaire 10 is not suitable for heat sinking. Therefore, the luminaire components such the lighting control unit 31 and the light source(s) 32 are attached to a heat sink 25 inside the luminaire housing 21. FIGS. 4A and 4B show a picture of an existing outdoor luminaire without RF equipment integrated. FIG. 4C shows an inside perspective view of a the luminaire of FIGS. 4A and 4B with integrated RF communication device. As can be seen, the shape and EPA of the integrated version of the luminaire as shown in FIG. 4C is not substantially different from the shape and EPA of the luminaire without RF communication device. The plastic housing material of the luminaire 10 is transparent for RF waves and hence the entire RF communication device 85, including the antenna part 70, can be included inside the luminaire 10. Thus, similar considerations as described above, apply here. The heat sink 25 of the luminaire 10 can be modified to include the heat sinking function for the RF communication device 85, making heat sinking elements in the RF communication device 85 superfluous, and thus weight increase of the additional RF communication device is minimized. At the same time, also the size of the RF communication device 85 is reduced because of largely eliminating heat sinking elements at the RF communication device 85, making it easier to integrate the RF communication device 85 in the luminaire 10. What remains or needs to be added are heat conduction element to transport heat from the RF communication device 85 to the heat sink 25 of the luminaire 10, e.g., via brackets 26. Modifications to the heat sink 25 of the luminaire 10 may include some additional heat conductive elements to the RF communication device 85 as discussed above and may include a (although limited) redesign or resizing of the heat sink of the luminaire to accommodate for higher heat sinking capacity, if needed. In addition to providing heat sinking capacity to an integrated RF communication device, the luminaire also provides reliable, surge protected, power for the RF communication device.

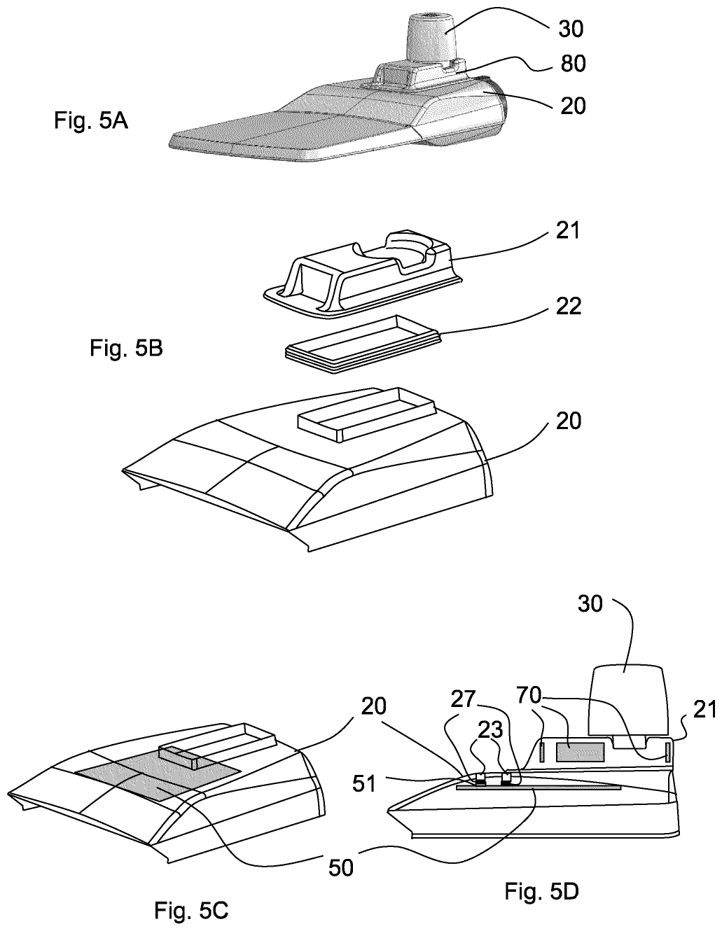

A third example embodiment is shown in FIGS. 5A, 5B, 5C and 5D. Here, the metal luminaire housing 20 is combined with a plastic housing element 21, possibly combined with a liquid-proofing barrier (e.g. a gasket 22). The plastic housing element 21 is used to integrate one or more RF antennas 70, and thus provide a weather-proof environment that is transparent for RF signals. The antennas are functionally connected to but separate from baseband unit 50, depicted as a PCB. The baseband unit 50 is integrated inside the metal housing 20. Besides the baseband unit 50, additional electronic modules, such as modems, may be integrated, either inside the antenna housing 21 or inside the metal housing 20. The baseband unit 50 (and/or other electronic modules) will have electronic components 51 that need to be cooled for optimum performance and lifetime. The metal housing 20, may have thermally conductive protrusions 23 (often called “studs” or “heat studs”) that are brought in thermal contact with the temperature-critical electronic components of the base unit 50 (and/or other electronic modules), usually assisted by a flexible thermal interface 27 such as a so-called “thermal pad” or “thermal grease”. Thus, heat is effectively transferred from the electronic components towards the metal housing. The metal housing, in turn, spreads the heat and transfers it to the environment (to air). Similarly, the antennas 70, although encased by a plastic housing, may be thermally connected to the luminaire housing via metal brackets that act in a similar way as the thermally conductive protrusions or heat studs 23. Although not explicitly shown in the FIGS. 5A to 5D, the metal luminaire housing 20 is also in thermal contact with the lighting unit to sink heat from the lighting unit towards the environment, as known in the art.

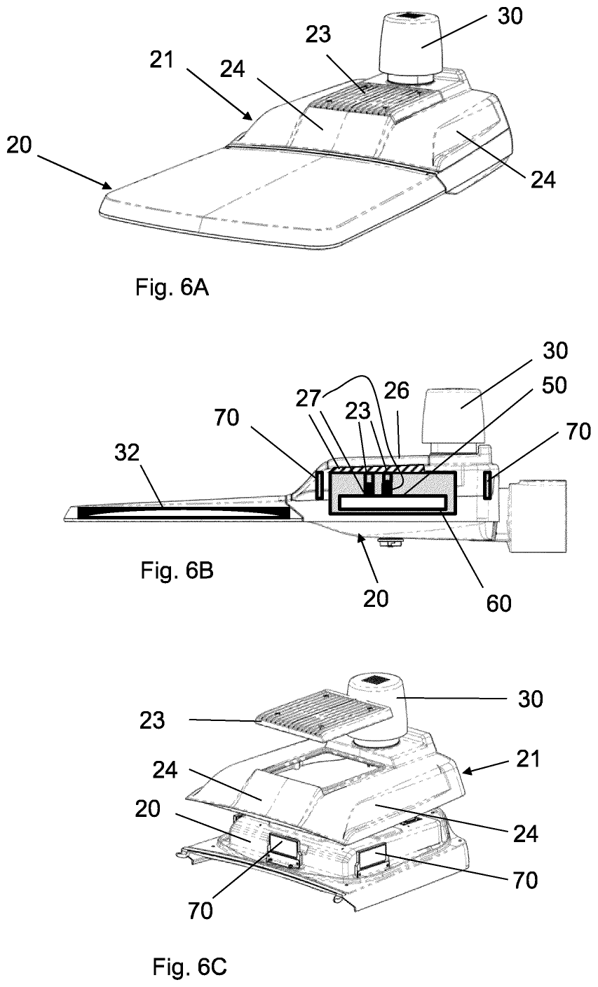

A fourth example embodiment is shown in FIGS. 6A, 6B and 6C. Here, the metal housing 20 has an additional heat sink part 23 which has two main functions. It acts as an efficient heat sink by incorporating an enlarged surface area on the top side, through the use of fins or ribs, and it acts as a mechanical fixation device to connect the plastic housing 21 to the metal housing 20. The plastic housing 21 contains compartments 24 to encase antennas 70. These compartments provide weather-proof protection for the antennas while using RF-transparent materials, typically plastic. To create liquid-proof or weather-proof connection between the plastic housing 21 and metal housing 20, an intermediate material such as a gasket may be used. The effectiveness of such a gasket may be improved by pressure in connecting the plastic housing 21 with the metal housing 20. Such pressure may be provided through the mechanical fixation function of heat sink part 23, e.g. by a screwed connection from heat sink part 23 to housing 20 with plastic housing 21 in between. In this embodiment, a RF communication device concept similar to the one depicted in FIG. 3E is used. A radio unit 60, which is embodied as a ‘brick’, provides an at least partially metal housing for a baseband unit 50 and possible additional electronic modules such as modems incorporated therein. The housing of the radio has multiple functions: it provides ruggedness and potentially liquid-proof enclosure for integration in various types of lighting units. In addition, it provides electromagnetic shielding. Finally, it provides heat sinking of the electronics components housed therein, potentially by using metal protrusions 23 and flexible thermal interfaces 27 for improved thermal contact. The housing of the radio, in turn, is thermally connected to the luminaire housing 20, through the use of metal-metal connections, whereby thermal contact may be enhanced by using materials such as thermal pads or thermal grease 27. The advantage of embodiment in FIG. 6A-C over the embodiment in FIG. 5A-D is that it reduces the height of the overall luminaire, and thus reduces the effective projected area EPA. The embodiment described in FIG. 5A-D on the other hand has the advantage of a simpler mechanical construction.

In preferred embodiments, the RF communication device or functional elements thereof such as the baseband units, the radio or the antenna are arranged relative to the light source(s) such that their presence does not interfere with the optical path of the light source(s) of the luminaire. For example, when the light source(s) are arranged as an LED arrangement, e.g., an LED array, on a PCB—such that their light output is directed in a light emission direction away from the PCB, then the RF communication device or functional elements thereof may be arranged at an opposite side of an imaginary plane comprising the PCB. Alternatively, the RF communication device or functional elements thereof may be arranged at same side of an imaginary plane comprising the PCB but away from the LED arrangement, for example aside or adjacent the LED arrangement. The RF communication device or its functional elements may or may not be mounted on that PCB comprising the LED arrangement.

Depending on the size and design of the heat sink of the luminaire, in embodiments the light source(s) of the luminaire may be arranged at and thermally connected to one side of the heat sink and the RF communication equipment or functional elements thereof may be are arranged at and thermally connected to an opposite side of the heat sink. Alternatively, the RF communication device or functional elements thereof may be arranged at and thermally connected to the heat sink at same side of the side where the light sources are arranged and thermally connected at the heat sink. Further, in other embodiments some functional elements of the RF communication device may be arranged at and thermally connected to one side of the heat sink and other functional elements of the RF communication device may be arranged at and thermally connected to an opposite side of the heat sink. A particular implementation of any of these alternatives depends, amongst others, on the size and design of the heat sink and the available location(s) and space for heat sinking functionality in the luminaire.

As touched upon above, the separation of functional elements of the RF communication device into separate modules or blocks and stripping or reducing the heat sinking elements from the RF communication device substantially reduces the size of the RF communication modules or blocks to be integrated in or onto the luminaire. The separation of the RF communication device into separate functional modules or blocks for integration in or onto a luminaire may require some hardware and/or software redesign of modules or blocks in order to provide the correct functional separation. The overall occupied space, volume or footprint of the plurality of separated, optionally redesigned, functional modules of the RF communication device will generally be smaller than and/or better optimized for luminaire integration than the occupied space, volume or footprint of the original unitary RF communication devices as illustrated in FIG. 1.

As demonstrated in the present disclosure, with the claimed invention, the form factor and/or ornamental design of luminaires does not have to be substantially impacted by integrating RF communication functionality in a luminaire. Luminaires with integrated RF communication functionality and luminaires without RF communication functionality can therefore be mixed unnoticed to users in urban areas.

In preferred embodiments, the RF communication device is a mmWave backhaul device or a 5G communication device.

The above examples as described are only illustrative, and not intended to limit the technique approaches of the present invention. Although the present invention is described in detail referring to the examples disclosed, those skilled in the art will understand that the technique approaches of the present invention can be modified or equally displaced without departing from the spirit and scope of the technique approaches of the present invention, which will also fall into the protective scope of the claims of the present invention.

For example, the concepts and embodiments disclosed and illustrated in connection with outdoor luminaires can equally applied to indoor luminaires comprising a wireless RF communication device, wherein at least a part of the lighting unit of the indoor luminaire and at least a part of the wireless RF communication device are in thermal contact with a common heat sink component. Any of the preferred features disclosed herein with respect to outdoor luminaires may equally be applied to indoor luminaires. Application areas for such indoor luminaires include offices, public venues, evenement halls, shopping malls, etc.

In the claims, the word “comprising” does not exclude other elements or steps, and the indefinite article “a” or “an” does not exclude a plurality. Any reference signs in the claims should not be construed as limiting the scope.

1. A luminaire comprising:
a lighting unit, and
a wireless RF communication device,
wherein at least a part of the lighting unit and at least a part of the wireless RF communication device are in thermal contact with a common heat sink component, and wherein the wireless RF communication device is a mmWave device used for backhaul, fronthaul or midhaul communication.

2. The luminaire of claim 1, where the common heat sink component is comprised by at least part of a luminaire housing.

3. The luminaire of claim 1, where the common heat sink component is located within a confined space created by at least part of a luminaire housing.

4. The luminaire of claim 1, wherein
the luminaire comprises a luminaire housing at least partially comprising of a metal housing,
the wireless RF communication device comprises a baseband unit, a radio and an antenna, and
wherein the baseband unit and/or the radio of the wireless RF communication device is comprised within a confined space created by the metal housing of the luminaire and wherein
the antenna of the wireless RF communication device is located outside the confined space created by the metal housing of the luminaire, or
the antenna of the wireless RF communication device is comprised within the confined space created by the metal housing of the luminaire wherein the metal housing has non-metal areas near the antenna, the non-metal areas being made of a material that is transparent for RF signals.

5. The luminaire of claim 4, wherein the baseband unit, the radio and/or the antenna of the wireless RF communication device is in mechanical and/or thermal contact with the metal housing of the luminaire housing, wherein the metal housing comprises the common heat sink component.

6. The luminaire of claim 1, wherein
the luminaire comprises a luminaire housing at least partially comprising a non-metallic housing transparent for RF radio signals,
the wireless RF communication device comprises a baseband unit, a radio and an antenna, and
wherein at least the antenna of the wireless communication device is comprised within a confined space created by the non-metallic housing of the luminaire.

7. The luminaire of claim 6, wherein the baseband unit, the radio and/or the antenna of the wireless RF communication device is in mechanical and/or thermal contact with the heat sink component, wherein the common heat sink component is located within the confined space created by the non-metallic housing of the luminaire housing.

8. The luminaire of claim 6, wherein the non-metallic housing comprises a plastic material.

9. The luminaire of claim 1, wherein the wireless RF communication device is void of an own heat sink and is arranged to sink its heat to the common heat sink component.

10. (canceled)

11. The luminaire of claim 1, wherein the luminaire is an outdoor luminaire or a indoor luminaire.

12. Use of a luminaire of claim 11 in a 5G broadband cellular network.

13. (canceled)

14. Use of a luminaire of claim 11 in a network comprising security cameras.

15. Use of a luminaire of claim 11 in a network comprising IOT devices selected from environmental sensors, sound systems, microphones, loudspeakers and digital displays.
